(19) United States
(12) Patent Application Publication
(10) Pub. No.: US 2026/0054974 A1
(43) Pub. Date: Feb. 26, 2026

(54) WATER OUTLET MECHANISM AND SPARKLING WATER MACHINE

(71) Applicant: i-Drink Products Inc., Ann Arbor, MI (US)

(72) Inventors: Jiangang Guo, Foshan City (CN); Chaoming Chen, Foshan City (CN)

(73) Assignee: i-Drink Products Inc., Ann Arbor, MI (US)

(21) Appl. No.: 19/066,386

(22) Filed: Feb. 28, 2025

(30) Foreign Application Priority Data
Aug. 26, 2024 (CN) 202422082349.6

(51) Int. Cl. B67D 1/04; B67D 1/08

(52) U.S. Cl. CPC B67D 1/0418; B67D 2001/0824

(57) ABSTRACT

A water dispensing mechanism for a sparkling water bottle is disclosed. The mechanism includes a water outlet pipe located inside the sparkling water bottle, a water outlet channel, a water outlet connected to the water outlet channel, and a pressing assembly positioned proximate to a bottle cap or bottle body of the sparkling water bottle, wherein the pressing assembly is configured to move relative to the sparkling water bottle between a first position and a second position. The pressing assembly cuts off a connection between the water outlet channel and the water outlet pipe when in a first position and, when in the second position, establishes a connection between the water outlet channel and the water outlet pipe, allowing the sparkling water inside the sparkling water bottle to sequentially flow through the water outlet pipe, the pressing assembly, and the water outlet channel, then exit through the water outlet.

### CROSS REFERENCE TO RELATED APPLICATIONS

This application claims the benefit of Chinese Patent Application No. 202422082349.6 filed Aug. 26, 2024, which is hereby incorporated herein by reference.

### TECHNICAL FIELD

This disclosure relates to beverage equipment, and more particularly to a water dispensing mechanism and a sparkling water machine.

### BACKGROUND

The statements in this section merely provide background information related to the present disclosure and may not constitute prior art.

Currently, soda machines on the market that are used to make sparkling water require the bottle cap to be removed in order to pour out the sparkling water. For example, the Chinese patent with the publication number CN103720363B, which discloses a soda water machine with a concentrated juice powder spraying device, requires the user to remove the gas injection port (equivalent to the bottle cap) from the bottle opening of the pressurized water bottle after the sparkling water is prepared and when the user needs to drink it. The sparkling water must then be poured out. This operation is relatively cumbersome and causes inconvenience for the user. Hence there is a need for an improved water dispensing mechanism and a sparkling water machine.

### SUMMARY

In view of the above problems in the prior art, the objective of the embodiments of this application is to provide a water dispensing mechanism and a sparkling water machine with the mechanism, which can allow the sparkling water inside the bottle to flow out without the need to remove the bottle cap.

The technical solution employed in the embodiment of this application is a water dispensing mechanism designed for bottles containing sparkling water. The water dispensing mechanism comprises a water outlet pipe located inside the bottle, along with a water outlet channel, a water outlet, and a pressing assembly, all situated at the bottle's cap or body of the bottle. The water outlet is connected to the water outlet channel.

The pressing assembly is capable of moving relative to the bottle and has a first position and a second position. When the pressing assembly is in the first position, it cuts off the connection between the water outlet channel and the water outlet pipe; When the pressing assembly is in the second position, the water outlet channel is connected to the water outlet pipe, allowing the sparkling water inside the bottle to sequentially flow through the water outlet pipe, the pressing assembly, and the water outlet channel, and then exit through the water outlet.

In an optional embodiment, the pressing assembly comprises a water chamber and a water inlet and water outlet hole connecting with the water chamber. The water inlet is connected to the upper end of the water outlet pipe, allowing the sparkling water inside the bottle to enter the water chamber via the water outlet pipe. When the pressing assembly is in the first position, the water outlet hole is not aligned with the other end of the water outlet channel, and the connection between the water outlet pipe and the water outlet channel is cut off, preventing the sparkling water inside the bottle from entering the water outlet channel. When the pressing assembly is in the second position, the water outlet hole is aligned with the other end of the water outlet channel, and the water outlet pipe is connected to the water outlet channel, allowing the sparkling water inside the bottle to enter the water outlet channel and exit through the water outlet. The structure of the pressing assembly is well-designed, facilitating the switching between the first and second positions, thus establishing or disconnecting (cutting off) the connection between the water outlet pipe and the water outlet channel.

In an optional embodiment, the pressing assembly comprises a main body, a pressing piece, and a reset piece.

The main body is fixed inside the bottle cap, and the main body houses the water chamber. The water chamber extends through the upper end of the main body to form an open end at the upper part of the main body. The water inlet is located at the lower end of the main body, and the side of the main body has an opening connecting with the water chamber. The other end of the water outlet channel is connected to the opening.

The lower part of the pressing piece extends into the water chamber through the open end of the main body and seals the open end. The lower part of the pressing piece has a channel that extends to its bottom end. The side of the lower part of the pressing piece is provided with the water outlet hole, which connects with the channel, and the peripheral side of the pressing piece is sealed and closely fits with the inner wall of the water chamber. The upper part of the pressing piece extends out of the bottle cap to form a pressing portion. When the pressing portion is pressed, the lower part of the pressing piece moves along the water chamber, causing the water outlet hole to either misalign or align with the water outlet channel.

The reset piece is located between the main body and the pressing piece and is used to apply a force to the pressing piece, causing it to return from the second position to the first position. The structure of the pressing assembly is simple and reasonable in principle, easy to operate, and cost-effective to manufacture. In an optional embodiment, the main body is cylindrical, with the water chamber extending axially along the main body. The cross-section of the water chamber is circular. The lower end of the pressing piece is hollow and tubular, and it is configured to fit with the water chamber; and/or the lower part of the pressing piece is fitted with a first sealing ring located above and below the water outlet hole, respectively. In this way, a seal is formed between the outer side of the lower part of the pressing piece and the inner wall of the water chamber, effectively preventing leakage.

In an optional embodiment, the water inlet extends downward to form a connector that extends into the bottle, and the upper end of the water outlet pipe is connected to the connector. In this way, it facilitates the connection between the water inlet of the main body and the water outlet pipe. In an optional embodiment, the side of the bottle cap extends outward to form a protruding portion, and the water outlet is located on the downward-facing side of the free end of the protruding portion. The water outlet channel extends from the bottle cap to the water outlet on the protruding portion.

This design makes it easier to set up the water outlet channel and the water outlet.

In an optional embodiment, the bottom edge of the pressing portion extends outward to form a limiting structure; the bottle cap is provided with a through hole, and the pressing portion extends through the through hole out of the bottle cap. When the pressing piece is in the first position, the limiting structure abuts against the lower edge of the through hole. This design prevents the pressing piece from detaching from the bottle cap when returning to the first position, enhancing the safety and reliability of the product.

A sparkling water machine, including a gas cylinder and a water bottle, where the gas cylinder is used to supply gas into the water bottle to form sparkling water inside the water bottle, the sparkling water machine further comprises the water dispensing mechanism in any of above embodiments, with the water dispensing mechanism being provided on the bottle cap of the bottle. This sparking water machine enables the release of the carbonated water from the water bottle through the water dispensing mechanism without the need to remove the bottle cap, thereby enhancing user convenience.

In an optional embodiment, the sparkling water machine further comprises a base, with the base being provided with a gas supply connector, and the intake end of the gas supply connector being in connection with the gas cylinder through a gas supply pipe.

The lower bottle opening of the water bottle is provided with a bottle bottom cover, and the bottle bottom cover is equipped with a gas inlet in connection with the interior of the water bottle. The gas inlet is provided with a check valve, and the gas outlet end of the gas supply connector is connected to the check valve to control the opening and closing of the check valve. Where, when the gas cylinder is opened to supply gas into the water bottle, the check valve opens under the pressure of the gas in the gas cylinder, allowing the gas from the gas cylinder to enter the water bottle. When the gas cylinder is closed, the check valve closes. The quick connection between the gas supply pipe of the gas cylinder and the check valve is achieved through the gas supply connector. The setting of check valve ensures that the gas from the gas cylinder can enter the water bottle, while preventing the carbonated water inside the bottle from flowing out through the gas inlet.

In an optional embodiment, the check valve comprises a valve body and a valve sleeve.

The valve body is provided with a valve chamber, and the gas outlet end of the gas supply connector extends into the valve chamber and forms a seal with the inner wall of the valve chamber. The upper part of the valve body forms the gas outlet end, and the circumferential side of the gas outlet end is provided with a gas outlet.

The valve sleeve is fitted over the gas outlet end and covers the gas outlet. The gas outlet end extends into the gas inlet, and the valve sleeve seals the gas inlet. When the gas cylinder is opened to supply gas into the valve chamber, the valve sleeve deforms under the action of the gas to open the gas outlet. The check valve exhibits a simple structure and good performance. Compared to existing technologies, the beneficial effect of this application embodiment is that the water dispensing mechanism of this application can control the outflow of sparkling water from the bottle without requiring the user to remove the bottle cap and pour out the sparkling water when they need to drink, thereby enhancing ease of use.

It should be understood that the foregoing general description and the following detailed description are merely illustrative and explanatory, and are not intended to limit the scope of the application.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a cross-sectional view of the water dispensing mechanism of an embodiment of the present disclosure, showing a water dispensing mechanism applied to a water bottle, with a pressing assembly in a first position.

FIG. 2 is an enlarged view of section A in FIG. 1.

FIG. 3 is a cross-sectional view of the water dispensing mechanism of the embodiment of the present application, showing the water dispensing mechanism applied to a water bottle, with the pressing assembly in the second position.

FIG. 4 is an enlarged view of section B in FIG. 3.

FIGS. 5 and 6 are sectional views of the sparkling water machine according to an embodiment of the present application, shown from different perspectives.

FIG. 7 is an enlarged view of section C in FIG. 6.

FIG. 8 is a schematic diagram showing the state of the sparkling water machine inflating the water bottle according to an embodiment of the present application.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment. Similarly, the phrase “in some embodiments,” as used herein, when used multiple times, does not necessarily refer to the same embodiments, although it may.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

As used herein, the term “or” is an inclusive “or” operator, and is equivalent to the term “and/or,” unless the context clearly dictates otherwise. The term “based, in part, on”, “based, at least in part, on”, “based upon” or “based on” is not exclusive and allows for being based on additional factors not described, unless the context clearly dictates otherwise.

Additionally, examples in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Likewise, the terms “first,” “second,” and similar terms used herein do not signify any order, quantity, or importance, but are merely used to distinguish between different parts. Nevertheless, it is still the same object. Further, the terms “including,” “comprising,” “having,” and variations thereof mean “including but not limited to” unless expressly specified otherwise. Further, the term “plurality” can be defined as “at least two.”

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In order to keep the following description of the embodiments of this application clear and concise, detailed explanations of known functions and known components are omitted.

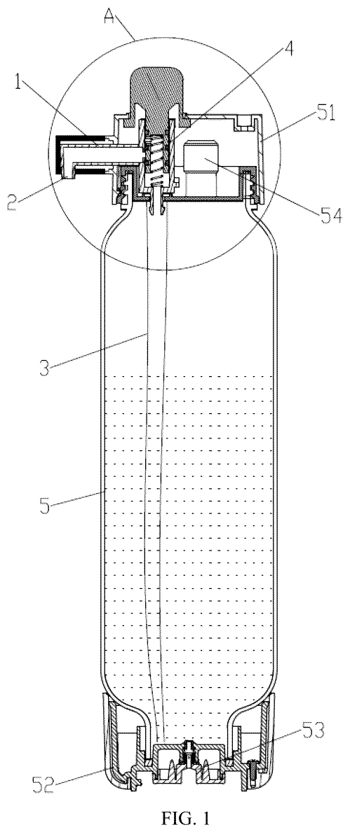

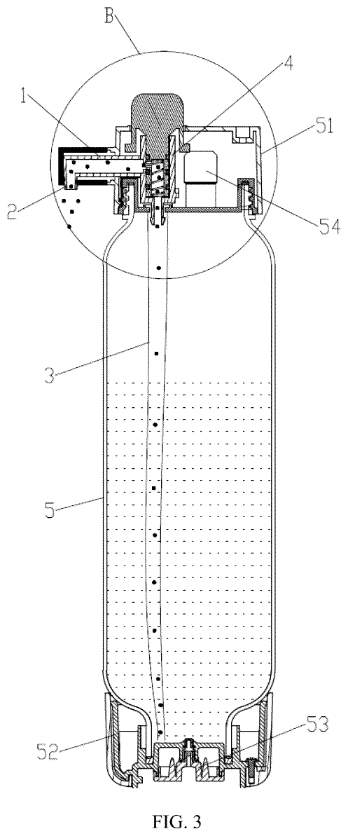

As shown in FIGS. 1 and 3, the embodiment of this application provides a water dispensing mechanism, which, for example, can be used on a water bottle 5 for making soda water. It can be understood that the water bottle 5 may contain not only soda water but also other carbonated beverages, meaning the water bottle 5 is pressurized to a level slightly higher than the external atmospheric pressure. For convenience of description, the term “carbonated water” will be used to refer to soda water and other carbonated beverages in the following sections.

The water dispensing mechanism comprises a water outlet pipe 3 located inside the water bottle 5, as well as a water outlet channel 1, a water outlet 2, and a pressing assembly 4 positioned at the bottle cap 51 or bottle body of the water bottle 5, where the water outlet 2 is connected to the water outlet channel 1. The pressing assembly 4 can move relative to the water bottle 5 and has a first position and a second position. When the pressing assembly 4 is in the first position, it cuts off the connection between the water outlet channel 1 and the water outlet pipe 3. When the pressing assembly 4 is in the second position, the water outlet channel 1 is connected to the water outlet pipe 3, allowing the sparkling water inside the water bottle 5 to sequentially flow through the water outlet pipe 3, the pressing assembly 4, and the water outlet channel 1, and then exit through the water outlet 2.

It can be understood that the water dispensing mechanism of the present application can be installed either at the bottle neck of the water bottle 5 or at the upper part of the bottle body of the water bottle 5. When the water dispensing mechanism is installed at the bottle neck, all the components constituting the water dispensing mechanism are arranged on the bottle cap 51. When the water dispensing mechanism is installed on the bottle body, a through hole, which connects with the interior of the water bottle 5, needs to be created on the bottle body. The position of the through hole is above the liquid level inside the water bottle 5, and a sealing cover is provided at the through hole. All the components constituting the water dispensing mechanism are arranged on the sealing cover. The following section will provide a detailed explanation using the example where the water dispensing mechanism is installed on the bottle cap 51.

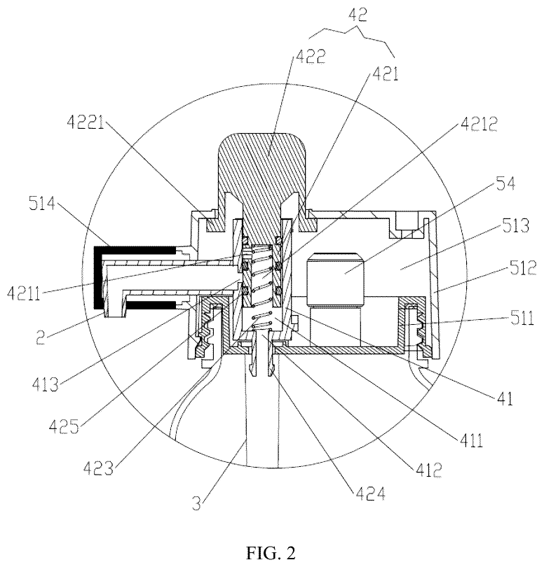

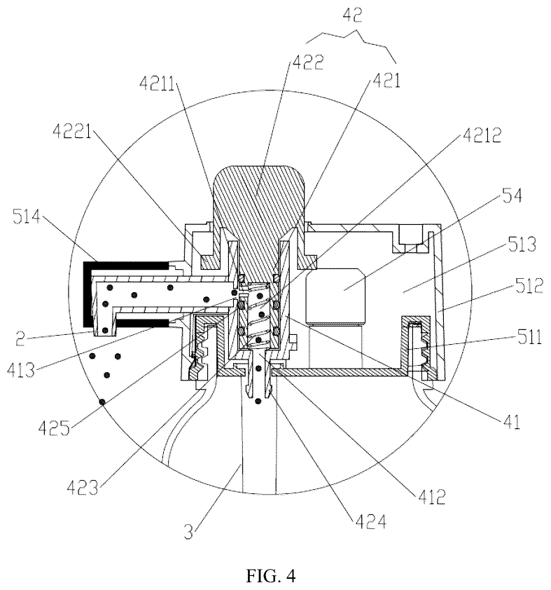

As shown in FIGS. 2 and 4, the water dispensing mechanism comprises the water outlet channel 1, the water outlet 2, the water outlet pipe 3, and the pressing assembly 4. The water outlet channel 1 is located on the bottle cap 51. The water outlet 2 is set on the bottle cap 51 and connected to one end of the water outlet channel 1, or the water outlet 2 extends from one end of the water outlet channel 1 to the peripheral or bottom side of the bottle cap 51.

The sparkling water inside the water outlet channel 1 can flow out through the water outlet 2 and be provided to the user. The water outlet pipe 3 is located inside the water bottle 5. The lower end of the water outlet pipe 3 extends below the water surface in the water bottle 5, while the upper end of the water outlet pipe 3 is positioned near the bottle cap 51.

To ensure that all the sparkling water inside the water bottle 5 flows out and to avoid waste, the lower end of the water outlet pipe 3 can extend to the bottom of the water bottle 5. The pressing assembly 4 is arranged on the bottle cap 51 and positioned between the other end of the water outlet channel 1 and the upper end of the water outlet pipe 3. It is used to cut off or establish the connection between the water outlet pipe 3 and the water outlet channel 1. In other words, by operating the pressing assembly 4, it is possible to either connect the other end of the water outlet channel 1 with the upper end of the water outlet pipe 3 or cut off the connection between the other end of the water outlet channel 1 and the upper end of the water outlet pipe 3. The pressing assembly 4 is capable of moving relative to the bottle cap 51 and has a first position and a second position. When the pressing assembly 4 is in the first position, the pressing assembly 4 cuts off the connection between the water outlet channel 1 and the water outlet pipe 3, that is, the sparkling water inside the water outlet pipe 3 cannot flow into the water outlet pipe 1; When the pressing assembly 4 is in the second position, the pressing assembly 4 connects the water outlet channel 1 to the water outlet pipe 3, allowing the sparkling water inside the water bottle 5 to sequentially flow through the water outlet pipe 3, the pressing assembly 4, and the water outlet channel 1, and then exit through the water outlet 2.

The water dispensing mechanism of embodiment in this application allows the sparkling water inside the water bottle 5 to flow into the water outlet channel 1 and out of the water outlet 2 by pressing the pressing assembly 4. This enables the user to directly control the flow of sparkling water from the water bottle 5 by simply operating the pressing assembly 4, without needing to remove the bottle cap 51 or tip the water bottle 5 to pour out the sparkling water, improves convenience and provides a better user experience.

In some embodiments, continuing with reference to FIGS. 2 and 4, the pressing assembly 4 comprises a water chamber 411, and a water inlet 412 connected to the water chamber 411, and a water outlet hole 4211. The water inlet 412 is connected to the upper end of the water outlet pipe 3, allowing the sparkling water inside the water bottle 5 to flow in through the water outlet pipe 3 and into the water chamber 411. When the pressing assembly 4 is in the first position, the water outlet hole 4211 is not aligned with the other end of the water outlet channel 1, and the connection between the water outlet pipe 3 and the water outlet channel 1 is cut off, preventing the sparkling water inside the water bottle 5 from entering the water outlet channel 1. When the pressing assembly 4 is in the second position, the water outlet hole 4211 is aligned with the other end of the water outlet channel 1, and the water outlet pipe 3 is connected to the water outlet channel 1, allowing the sparkling water inside the water bottle 5 to enter the water outlet channel 1, and then exit through the water outlet 2. The structure of the pressing assembly 4 is well-designed, facilitating the switching between the first and second positions, thus establishing the connection or disconnection (cut-off) between the water outlet pipe 3 and the water outlet channel 1. As shown in FIGS. 2 and 4, the pressing assembly 4 comprises a main body 41, a pressing piece 42, and a reset piece 423.

The main body 41 is fixed inside the bottle cap 51. The main body 41 contains a water chamber 411, and the water chamber 411 extends through to the upper end of the main body 41, creating an open end at the top. The water inlet 412 is located at the lower end of the main body 41. A side opening 413 is provided on the side of the main body 41, which connects with the water chamber 411. The other end of the water outlet channel 1 is connected to the opening 413, with the two ends sealed at the connection, ensures that the sparkling water inside the water chamber 411 can only flow into the water outlet channel 1, preventing any leakage.

The lower part 421 of the pressing piece 42 extends through the open end of the main body 41 into the water chamber 411, sealing the open end to prevent the sparkling water inside the water chamber 411 from leaking through the open end. The lower part 421 of the pressing piece 42 is provided with a channel 4212 that extends through to its bottom end.

The lower part 421 of the pressing piece 42 has water outlet hole 4211 on its surrounding side, which connect with the channel 4212. Additionally, the outer side of the pressing piece 42 is sealed and closely fits against the inner wall of the water chamber 411. The upper part of the pressing piece 42 extends out of the bottle cap 51, forming the pressing portion 422. When the pressing portion 422 is pressed, the lower part 421 of the pressing piece 42 moves along the water chamber 411, causing the pressing piece 42 to shift from the first position to the second position, and the water outlet hole 4211 is no longer misaligned but aligned with the other end of the water outlet channel 1. Here, “aligned” does not mean that the water outlet hole 4211 and the other end of the water outlet channel 1 are perfectly aligned. It also encompasses situations where they are only partially aligned. When they are only partially aligned, the condition must be met that the sparkling water inside the water chamber 411 can flow through the water outlet hole 4211 into the water outlet channel 1.

The reset piece 423 is located between the main body 41 and the pressing piece 42 and is used to apply a force to the pressing piece 42, causing it to return from the second position to the first position, so the water outlet hole 4211 and the other end of the water outlet channel 1 change from being aligned to misaligned. The pressing piece 42 of this application can be switched from the first position to the second position under the action of an external force. When the pressure is released, it automatically returns to the initial state of the first position, thanks to the action of the reset piece 423. Moreover, the connection or disconnection of the water outlet pipe 3 and the water outlet channel 1 is achieved through pressing and automatic resetting. This design is simple and reasonable in structure, convenient and quick to operate, and cost-effective to manufacture.

When the pressing piece 42 is not pressed, it is in the first position, and the water outlet hole 4211 is not aligned with the other end of the water outlet channel 1, and the sparkling water inside the water bottle 5 cannot pass through the water outlet pipe 3 into the water outlet channel 1 (refer to FIG. 2). When the user needs to drink the sparkling water, they can press the pressing portion 422, causing the pressing piece 42 to move downward. As the pressing piece 42 moves to the second position, the water outlet hole 4211 is aligned with the other end of the water outlet channel 1 and connected. And during this process, pressure is applied to the water inside the water bottle 5. Once the water outlet hole 4211 is aligned with the other end of the water outlet channel 1, the water outlet pipe 3 and the water outlet channel 1 become connected. Under this pressure, the sparkling water inside the water bottle 5 flows into the outlet pipe 3, then through the water chamber 411 into the water outlet channel 1, and finally flows out through the water outlet 2 (refer to FIG. 3). The black dots in FIGS. 3 and 4 represent the flowing sparkling water. When the desired amount of sparkling water has flowed out, the user releases the pressing portion 422. The pressing piece 42 then returns to the first position under the action of the reset piece 423, waiting for the user's next use.

As shown in FIGS. 2 and 4, the main body 41 is cylindrical and vertically arranged. The water chamber 411 extends along the axial direction of the main body 41, and the cross-section of the water chamber 411 is circular. The lower part 421 of the pressing piece 42 is hollow and tubular, and it is configured to fit with the water chamber 411. The lower part (421) of the pressing piece (42) is fitted with a first sealing ring (425) located above and below the water outlet hole (4211), respectively, to seal the upper and lower sides of the water outlet hold 4211. In this way, a seal is formed between the outer side of the lower part 421 of the pressing piece 42 and the inner wall of the water chamber 411, ensuring that the sparkling water inside the water chamber 411 can only flow into the water outlet channel 1, preventing any leakage.

The specific structure of the reset piece 423 is not limited, as long as it is capable of providing the restoring force to return the pressing piece 42 from the second position to the first position. As shown in FIGS. 2 and 4, in this embodiment, the reset piece 423 is a spring. The upper end of the spring extends into the channel 4212 of the lower part 421 of the pressing piece 42 and rests against the top of the channel 4212. The channel 4212 acts as a stop to prevent the spring from shifting. The lower end of the spring is in contact with the bottom of the water chamber 411. When the pressing portion 422 is pressed down, causing the pressing piece 42 to move from the first position to the second position, the spring is compressed, storing elastic potential energy. When the force applied to the pressing portion 422 is released, the spring releases its stored energy and pushes the pressing piece 42 upward, returning the pressing piece 42 from the second position to the first position.

In some embodiments, continuing with reference to FIGS. 2 and 4, the water inlet 412 of the main body 41 extends downward to form a connector 424 that reaches into the water bottle 5. The upper end of the water outlet pipe 3 is connected to the connector 424. By providing the connector 424, the connection between the water outlet pipe 3 and the water inlet 412 of the main body 41 is made more convenient.

As shown in FIGS. 2 and 4, the side of the bottle cap 51 extends outward to form a protruding portion 514, and the water outlet 2 is located on the downward-facing side of the free end of the protruding portion 514. The water outlet channel 1 extends from the bottle cap 51 to the water outlet 2 on the protruding portion 514. By designing a protruding portion 514 on the bottle cap 51, sufficient space is provided for the setup of the water outlet channel 1. This also makes it easier to design the water outlet 2 in a downward-facing configuration, which is more convenient for the user to access the water.

In some embodiments, as shown in FIGS. 2 and 4, the outer side of the bottom end of the pressing portion 422 extends outward to form a limiting structure 4221. The limiting structure 4221 can be an annular or discontinuous flange. The bottle cap 51 is provided with a through hole (which is covered by the pressing portion 422 and is not shown). The pressing portion 422 passes through the through hole, extending outside the bottle cap 51. When the pressing piece 42 is in the first position, the limiting structure 4221 abuts against the lower peripheral edge of the through hole. By providing the limiting structure 4221, it prevents the pressing piece 42 from detaching from the bottle cap 51 when it is returning to the first position under the action of the reset piece 423. This also ensures that the pressing piece 42 is precisely positioned in the first position.

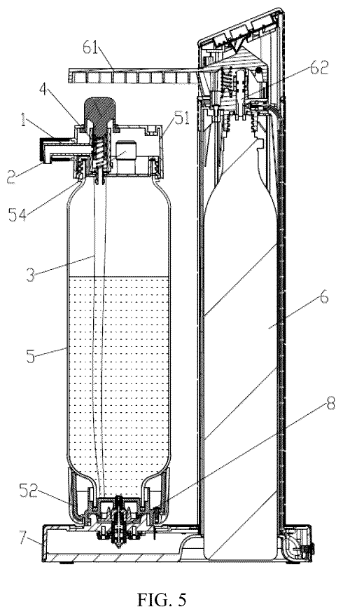

The embodiment of this application also provides a sparkling water dispenser. As shown in FIGS. 5, 6 and 8, a sparkling water machine, including a water bottle 5 and a gas cylinder 6, where the gas cylinder 6 is used to supply gas into the water bottle 5 to form sparkling water inside the water bottle 5; and the sparkling water machine further includes the water dispensing mechanism of any of above embodiments, the water dispensing mechanism being provided on the bottle cap 51 of the water bottle 5. This sparking water machine allows the release of the carbonated water from the water bottle 5 through the water dispensing mechanism without the need to remove the bottle cap 51, no need to lift the water bottle 5 to pour out the sparkling water, thereby enhancing user convenience.

As shown in FIGS. 2 and 4, the bottle cap 51 comprises an inner cap 511 and an outer cap 512. The inner cap 511 seals the upper bottle opening and forms a seal between the inner cap and the upper bottle opening. The outer cap 512 is placed over the inner cap 511, forming a chamber 513 with outer cap 512. The protruding portion 514 extends laterally outward from the side of the outer cap 512 and the protruding portion 514 is a hollow structure. This hollow structure is in connection with the chamber 513. The water outlet channel 1 is located within the hollow structure and the chamber 513. The main body 41 of the pressing assembly 4 is fixed inside the chamber 513, and the connector 424 at the bottom end of the main body 41 passes through the inner cap 511, extending into the water bottle 5. The through hole is located on the part of the outer cap 512 corresponding to the top end of the main body 41.

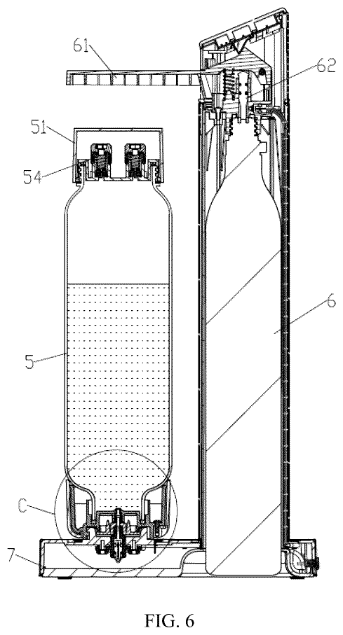

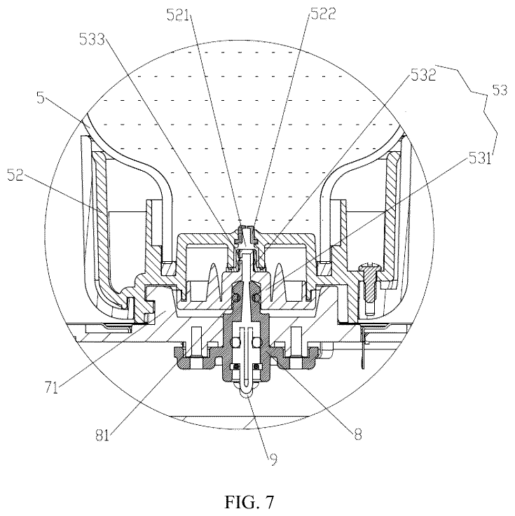

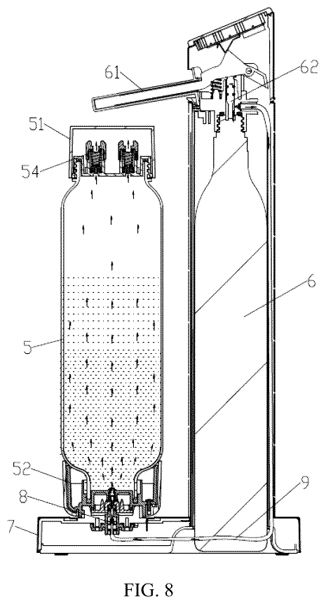

In some embodiments, as shown in FIGS. 5 and 6, the sparkling water machine also comprises a base 7. The base 7 has a gas supply connector 8 that extends from the top surface of the base 7. The intake end of the gas supply connector 8 is connected to the gas cylinder 6 via a gas supply pipe 9, as shown in FIG. 8. As shown in FIG. 7, the lower opening of the water bottle 5 is fitted with a bottle bottom cover 52. The bottle bottom cover 52 is equipped with a gas inlet 521 that connect with the interior of the water bottle 5. A check valve 53 is installed on the gas inlet 521. The output end of the gas supply connector 8 is connected to the check valve 53 and is used to control the opening and closing of the check valve 53. When the gas cylinder 6 is opened to supply gas into the water bottle 5, the check valve 53 opens under the pressure of the gas from the gas cylinder 6, allowing gas to enter the water bottle 5. When the gas cylinder 6 is closed, the check valve 53 closes to prevent any backflow of gas. The quick connection between the gas supply pipe 9 of the gas cylinder 6 and the check valve 53 is achieved through the gas supply connector 8. The setting of check valve 53 ensures that the sparkling water inside the water bottle 5 cannot flow out through inlet 521, while the gas inside the gas cylinder 6 can flow into the water bottle 5. The design is ingenious, featuring a straightforward structure.

As shown in FIG. 7, the top surface of the base 7 is provided with a mounting position 71 for the water bottle 5. The gas supply connector 8 is located at the corresponding mounting position 71 within the base 7, and the output end of the gas supply connector 8 extends into the mounting position 71. When the water bottle 5 is placed in the mounting position 71, the output end of the gas supply connector 8 is inserted into the check valve 53 on the bottle bottom cover 52. By setting the mounting position 71, the water bottle 5 can be easily positioned on the base 7, ensuring the stability of the connection between the gas supply connector 8 and the check valve 53. When the water bottle 5 is placed on the mounting position 71 of the base 7, the water bottle 5 and the gas cylinder 6 are arranged side by side.

In some embodiments, as shown in FIG. 7, the check valve 53 comprises a valve body 531 and a valve sleeve 532. The valve body 531 is provided with a valve chamber (not shown in the figure), and the gas outlet end of the gas supply connector 8 extends into the valve chamber and forms a seal with the inner wall of the valve chamber. Specifically, the valve cavity extends through to the bottom end of the valve body 531. The output end of the gas supply connector 8 extends into the bottom of the valve cavity, and a second sealing ring 81 is fitted onto the output end of the gas supply connector 8. The second sealing ring 81 is used to seal the gap between the outer peripheral wall of the output end and the inner wall of the valve cavity. The upper part of the valve body 531 forms the output end, and the outer side of the output end is provided with a gas outlet 533 that connects with the valve cavity, and the valve sleeve 532 is fitted onto the output end and covers the gas outlet 533. The output end extends into the gas inlet 521, and a seal is formed between the valve sleeve 532 and the gas inlet 521. When the gas cylinder 6 is opened to supply gas into the valve cavity, the valve sleeve 532 deforms under the pressure of the gas, creating a gap with the gas outlet end, thus the gas outlet 533 open, allowing the gas to flow through the gas outlet 533 into the gas inlet 521, and from gas inlet 521, it enters the water bottle 5. When the gas cylinder 6 is closed and the gas supply to the gas supply connector 8 is stopped, the valve sleeve 532 returns to its original position and tightly wraps around the gas outlet end of the valve body 531, closing the gas outlet 533. At this point, the check valve 53 is closed, preventing gas from entering the water bottle 5, and the sparkling water inside the water bottle 5 cannot flow out through the lower bottle opening.

The valve sleeve 532 can be made of materials such as silicone, which allows it to elastically deform and control the opening or closing of the gas outlet 533.

The end of the gas inlet 521 inside the water bottle 5 can be fitted with a nozzle 522, which facilitates the injection of gas from the gas cylinder 6 into the water inside the gas cylinder 6.

The gas inside the gas cylinder 6 can be high-pressure CO2. When the user presses down on the pressure rod 61 at the top of the gas cylinder 6, the pressure rod 61 pushes the ejector rod 62 downward, opening the gas cylinder 6 and releasing the high-pressure gas inside. The high-pressure gas first enters the gas supply pipe 9, and then sequentially passes through the gas supply connector 8 and the check valve 53 to enter the water bottle 5. Inside the water bottle 5, the high-pressure gas carbonates the drinking water. After the carbonation process is completed, any remaining gas inside the water bottle 5 is released through the safety valve 54. The water inside the water bottle 5 is now turned into sparkling water (soda water). Refer to FIG. 8, where the direction of the arrows indicates the flow direction of the gas.

### Reference Numerals

1—Water outlet channel; 2—Water outlet; 3—Water outlet pipe; 4—Pressing assembly; 41—Main body; 411—Water chamber; 412—Water inlet; 413—Opening; 42—Pressing piece; 421—Lower section; 4211—Water outlet; 4212—Channel; 422—Pressing portion; 4221—Limiting structure; 423—Reset piece; 424—Connector; 425—First sealing ring; Water bottle; 51—Bottle cap; 511—Inner cap; 512—Outer cap; 513—Cavity; 514—Protruding portion; 52—Bottle bottom cover; 521—Gas inlet; 522—Nozzle; 53—Check valve; 531—Valve body; 532—Valve sleeve; 533—Gas outlet; 54—Safety valve; Gas cylinder; 61—Pressure rod; 62—Ejector rod; 7—Base; 71—Mounting position; 8—Gas supply connector; 81—Second sealing ring; 9—Gas supply pipe.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A water dispensing mechanism for a sparkling water bottle, comprising:
a water outlet pipe located inside the sparkling water bottle;
a water outlet channel;
a water outlet connected to the water outlet channel; and
a pressing assembly positioned proximate to a bottle cap or bottle body of the sparkling water bottle, wherein the pressing assembly is configured to move relative to the sparkling water bottle between a first position and a second position, wherein:
when the pressing assembly is in the first position, it is configured to cut off a connection between the water outlet channel and the water outlet pipe, and
when the pressing assembly is in the second position, it establishes a connection between the water outlet channel and the water outlet pipe, allowing the sparkling water inside the sparkling water bottle to sequentially flow through the water outlet pipe, the pressing assembly, and the water outlet channel, then exit through the water outlet.

2. The water dispensing mechanism of claim 1, wherein the pressing assembly comprises:
a water chamber;
a water outlet hole that connects with the water chamber; and
a water inlet connected to an upper end of the water outlet pipe, permitting sparkling water communication inside the water bottle to flow in through the water outlet pipe into the water chamber.

3. The water dispensing mechanism of claim 2, wherein:
when the pressing assembly is in the first position, the water outlet hole is not aligned with an opposing end of the water outlet channel, cutting off a connection between the water outlet pipe and the water outlet channel, preventing sparkling water communication inside the water bottle from entering the water outlet channel; and
when the pressing assembly is in the second position, the water outlet hole is aligned with an opposing end of the water outlet channel, and the water outlet pipe is connected to the water outlet channel, allowing sparkling water communication inside the water bottle to enter the water outlet channel and exit through the water outlet.

4. The water dispensing mechanism of claim 3, wherein the pressing assembly further comprises:
a main body, wherein the main body is fixed inside the bottle cap, and the main body houses the water chamber, the water chamber extends through an upper end of the main body to form an open end at the upper part of the main body;
a pressing piece comprising:
a lower part extending into the water chamber through an open end of the main body and seals the open end, wherein the lower part comprises a channel that extends to its bottom end, and wherein a side of the lower part includes the water outlet hole connected to the channel, and wherein a peripheral side of the pressing piece is sealed and coupled to an inner wall of the water chamber, and
an upper part configured to extend out of the bottle cap to form a pressing portion, that, when pressed, is configured to move the lower part along the water chamber, causing the water outlet hole to either misalign with or align with the water outlet channel; and
a reset piece, wherein the reset piece is located between the main body and the pressing piece and is used to apply a force to the pressing piece, causing it to return from the second position to the first position.

5. The water dispensing mechanism of claim 4, wherein the water inlet is located at a lower end of the main body, wherein the main body comprises a side having an opening connected with the water chamber; and
wherein the water outlet channel is connected to the opening.

6. The water dispensing mechanism of claim 5, wherein the main body is cylindrical, and wherein the water chamber extends along an axial direction of the main body, the main body having a circular cross-section;
wherein the pressing piece includes a hollow and tubular lower end, and is configured to fit with the water chamber; and
wherein the lower part of the pressing piece is fitted with a sealing ring.

7. The water dispensing mechanism of claim 5, wherein the water inlet extends downward to form a connector that extends into the water bottle, and wherein the connector is connected to an end of the water outlet pipe.

8. The water dispensing mechanism of claim 1, wherein the bottle cap comprises a side that extends outward to form a protruding portion, and wherein the water outlet is located on a downward-facing side of a free end of the protruding portion, and wherein the water outlet channel extends from the bottle cap to the water outlet on the protruding portion.

9. The water dispensing mechanism of claim 5, wherein the pressing portion comprises a bottom edge that extends outward to form a limiting structure, wherein the bottle cap is provided with a through hole, and the pressing portion extends through the through hole out of the bottle cap, wherein the limiting structure abuts against the lower edge of the through hole when the pressing piece is in the first position.

10. A sparkling water machine, comprising:
a sparkling water bottle;
a gas cylinder, wherein the gas cylinder is configured to selectively supply gas into the water bottle to form sparkling water therein; and
a water dispensing mechanism comprising:
a water outlet pipe located inside the sparkling water bottle;
a water outlet channel;
a water outlet connected to the water outlet channel; and
a pressing assembly positioned proximate to a bottle cap or a bottle body of the sparkling water bottle, wherein the pressing assembly is configured to move relative to the sparkling water bottle between a first position and a second position;
wherein when the pressing assembly is in the first position, it is configured to cut off a connection between the water outlet channel and the water outlet pipe;
wherein when the pressing assembly is in the second position, it establishes a connection between the water outlet channel and the water outlet pipe, allowing the sparkling water inside the sparkling water bottle to sequentially flow through the water outlet pipe, the pressing assembly, and the water outlet channel, then exit through the water outlet; and
wherein with the water dispensing mechanism being provided on the bottle cap or a body of the water bottle.

11. The sparkling water machine of claim 10, wherein the sparkling water machine further comprises a base having a gas supply connector wherein the gas supply connector includes an intake end connected with the gas cylinder through a gas supply pipe; and
wherein the water bottle includes a lower bottle opening having a bottle bottom cover equipped with a gas inlet in connection with an interior of the water bottle, and in gaseous communication with a check valve;
wherein the gas supply connector includes a gas outlet end connected to the check valve; and
wherein the check valve is configured to selectively supply gas into the water bottle from the gas cylinder, allowing the gas from the gas cylinder to enter the water bottle, and wherein the check valve is configured to close when the gas cylinder is closed.

12. The sparkling water machine of claim 11, wherein the check valve comprises:
a valve body;
a valve sleeve having a valve chamber, wherein the gas outlet end of the gas supply connector extends into the valve chamber and forms a seal with the inner wall of the valve chamber;
wherein the valve body includes an upper part that forms the gas outlet end, and the circumferential side of the gas outlet end is provided with a gas outlet; and
wherein the valve sleeve is configured to seal the gas inlet, the valve sleeve is fitted over the gas outlet end and is configured to cover the gas outlet and extend into the gas inlet, the valve sleeve is configured to deform under the action of the gas to open the gas outlet when the gas cylinder is opened to supply gas into the valve chamber.
